(19) United States
(12) Patent Application Publication
(10) Pub. No.: US 2017/0010405 A1
(43) Pub. Date: Jan. 12, 2017

(54) LIGHT GUIDE PLATE, METHOD OF MANUFACTURING THE SAME, AND DISPLAY DEVICE INCLUDING THE LIGHT GUIDE PLATE

(71) Applicant: Samsung Display Co., Ltd., Yongin-Si (KR)

(72) Inventors: Hayoung LEE, Seoul (KR); Sangwon LEE, Seoul (KR); Hyun-hwa SONG, Hwaseong-si (KR); Seunghwan CHUNG, Seongnam-si (KR)

(21) Appl. No.: 15/083,385

(22) Filed: Mar. 29, 2016

(30) Foreign Application Priority Data
Jul. 7, 2015 (KR) 10-2015-0096742

(51) Int. Cl. F21V 8/00

(52) U.S. Cl. CPC G02B 6/0065; G02B 6/0035; G02B 6/0061

(57) ABSTRACT

A light guide plate includes a body and a light guide pattern. The body includes a glass doped with a dopant having photosensitivity and first regions spaced apart from each other are defined in the body. The light guide pattern includes a first pattern layer portion provided in plural inside the body to respectively correspond to the first regions. In addition, the first pattern layer has a higher refractive index than an intermediate portion of the body between two first pattern layer portions adjacent to each other.

This application claims priority to Korean Patent Application No. 10-2015-0096742, filed on Jul. 7, 2015, and all the benefits accruing therefrom under 35 U.S.C. §119, the content of which in its entirety is herein incorporated by reference.

### BACKGROUND

(1) Field

The invention relates to a light guide plate, a method of manufacturing the same, and a display device including the light guide plate, and more particularly, to a light guide plate including glass, a display device including the light guide plate, and a method of forming a light guide pattern of the light guide plate.

(2) Description of the Related Art

A display device such as a liquid crystal display device includes a backlight assembly generating and emitting light, and a display panel receiving the light to display an image. The backlight assembly may include a light source generating the light and a light guide plate guiding the light received from the light source toward the display panel.

The light guide plate may include or be made of a transparent plastic or a transparent glass according to the use thereof Although a plastic light guide plate may be easily manufactured when compared to a glass light guide plate, the plastic light guide plate has a limitation in that the appearance and structure thereof may be deformed due to heat and humidity.

On the other hand, although the glass light guide plate is superior in heat resistance and moisture resistance when compared to the plastic light guide plate, the glass light guide plate is brittle and thus may not be easily manufactured when compared to the plastic light guide plate.

### SUMMARY

One or more exemplary embodiment of the invention provides a light guide plate in which a light guide pattern is easily formed.

One or more exemplary embodiment of the invention also provides a method of easily forming a light guide pattern of a light guide plate.

One or more exemplary embodiment of the invention also provides a display device including a backlight assembly including the light guide plate.

An exemplary embodiment of the invention provides a light guide plate including a body and a light guide pattern. The body includes a glass doped with a dopant having photosensitivity and first regions spaced apart from each other are defined in the body. The light guide pattern includes a first pattern layer portion provided in plural inside the body to respectively correspond to the first regions. In addition, the first pattern layer portion has a higher refractive index than an intermediate portion of the body between two first pattern layer portions adjacent to each other.

In an exemplary embodiment of the invention, a method of manufacturing a light guide plate includes doping a dopant having photosensitivity into glass to define a body of the light guide plate; and irradiating first regions of the body with light to form a first pattern layer portion of a light guide pattern of the light guide plate, the first pattern layer portion provided in plural inside the body to correspond to each of the first regions. A refractive index of the first pattern layer portion is higher than a refractive index of an intermediate portion of the body between two first pattern layer portions.

In an exemplary embodiment of the invention, a display apparatus includes a backlight assembly which generates and emits light and a display panel which receives the light to display an image.

The backlight assembly includes a light source which generates the light and a light guide plate which guides the light from the light source toward the display panel.

The light guide plate includes a body and a light guide pattern. The body includes a glass doped with a dopant having photosensitivity and first regions spaced apart from each other are defined in the body. The body defines a light guide pattern of the light guide plate. The light guide pattern includes a first pattern layer portion provided in plural inside the body to respectively correspond to the first regions. In addition, the first pattern layer portion has a higher refractive index than an intermediate portion of the body between two first pattern layer portions adjacent to each other.

### BRIEF DESCRIPTION OF THE DRAWINGS

The accompanying drawings are included to provide a further understanding of the invention, and are incorporated in and constitute a part of this specification. The drawings illustrate exemplary embodiments of the invention and, together with the description, serve to explain principles of the invention. In the drawings:

FIG. 1A illustrates a perspective view of an exemplary embodiment of a light guide plate according to the invention,

FIG. 1B illustrates a cross-sectional view illustrating the light guide plate along line I-I′ in FIG. 1A,

FIG. 2 illustrates a cross-sectional view of another exemplary embodiment of a light guide plate according to the invention,

FIG. 3 illustrates a cross-sectional view of still another exemplary embodiment of a light guide plate according to the invention,

FIGS. 4A, 4B and 4C are cross-sectional views illustrating an exemplary embodiment of a method of manufacturing a light guide plate according to the invention,

FIGS. 5A and 5B are cross-sectional views illustrating another exemplary embodiment of a method of manufacturing a light guide plate according to the invention,

FIG. 6 illustrates an exploded perspective view of an exemplary embodiment of a display device to which the light guide plate illustrated in FIG. 1A is applied, and

FIG. 7 illustrates a cross-sectional view of the display device along line II-II′ in FIG. 6.

### DETAILED DESCRIPTION

Hereinafter, the invention will be described in detail by explaining exemplary embodiments of the invention with reference to the attached drawings. The objects, features, and effects of the invention will be readily understood through embodiments related to the accompanying drawings. The invention may, however, be embodied in various forms and should not be construed as limited to the exemplary embodiments set forth herein. Rather, these exemplary embodiments are provided so that this disclosure will be thorough and complete, and will fully convey the scope of the invention to those skilled in the art. Therefore, the scope of the invention should not be construed as being limited to the exemplary embodiments set forth herein. Meanwhile, reference numerals are used for referring to the same or similar elements in the description and drawings.

It will be understood that when an element is referred to as being “on” another element, it can be directly on the other element or intervening elements may be present therebetween. In contrast, when an element is referred to as being “directly on” another element, there are no intervening elements present.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10% or 5% of the stated value.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

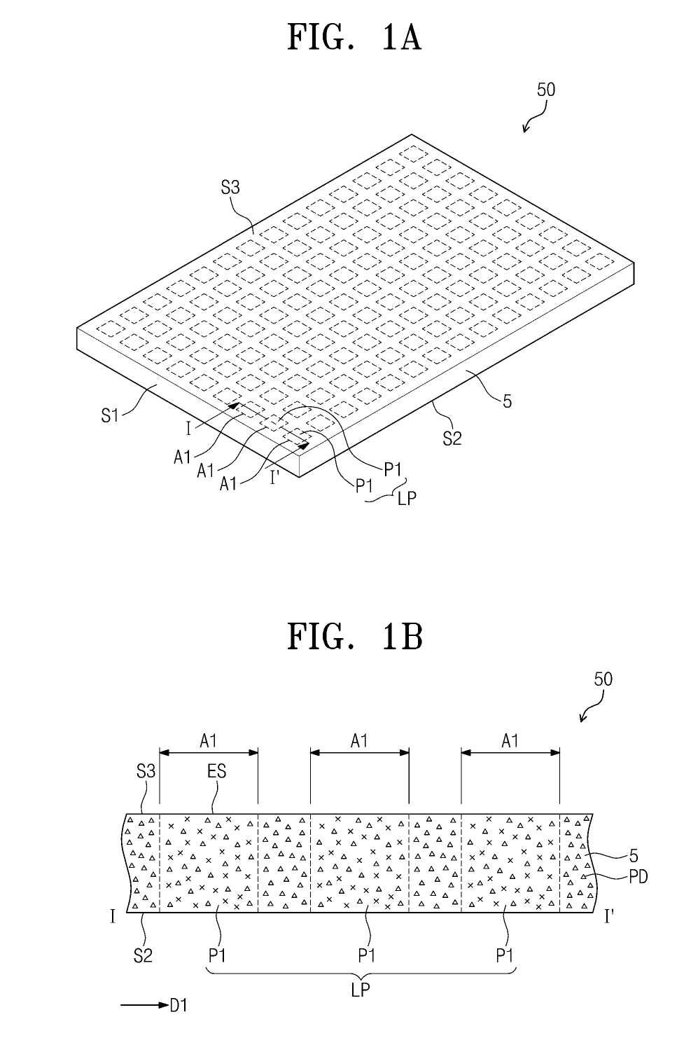

FIG. 1A illustrates a perspective view of an exemplary embodiment of a light guide plate according to the invention and FIG. 1B illustrates a cross-sectional view of the light guide plate along line I-I′ in FIG. 1A.

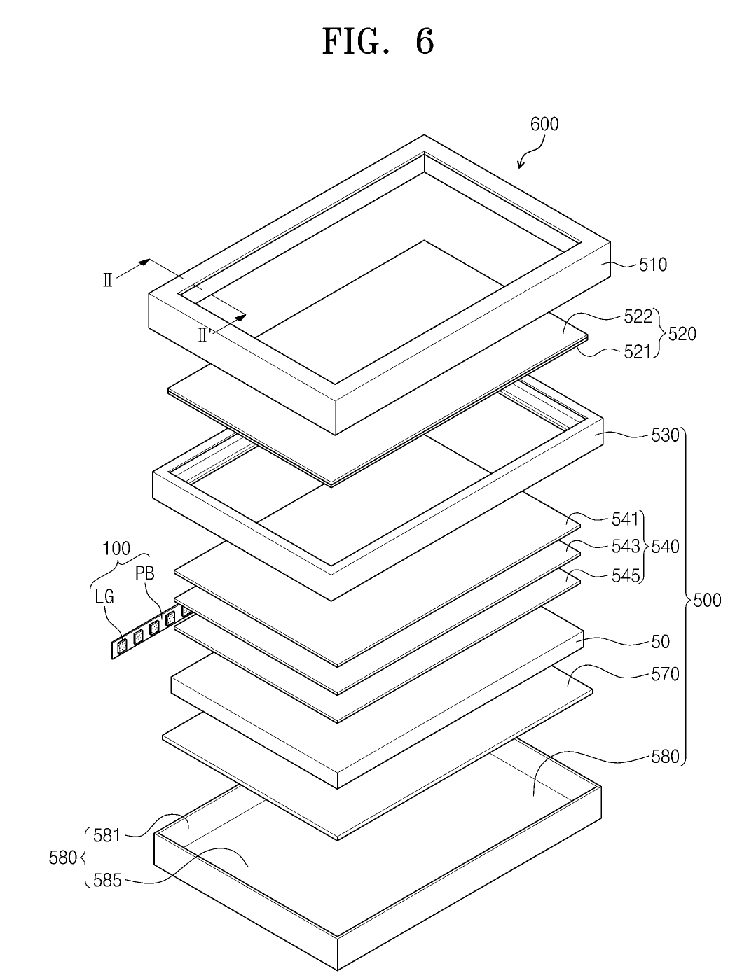

Referring to FIGS. 1A and 1B, a light guide plate 50 may be used as a component of a backlight assembly (500 in FIG. 6) of a display device (600 in FIG. 6). The light guide plate 50 guides light generated from a light emitting diode package (LG in FIG. 6) toward a display panel (520 in FIG. 6).

In the exemplary embodiment, the light guide plate 50 includes a body 5 and a light guide pattern LP. Light is incident inside the body 5 through an incident surface S1 and the incident light may be totally reflected inside of the body 5. In addition, the light totally reflected inside the body 5 may be refracted by the light guide pattern LP and the refracted light may be emitted outside the body 5 through an emitting surface S2.

The body 5 includes a body material such as glass and the body 5 is doped with a dopant PD. The body 5 may be defined by structures of the dopant PD within portions of the body material. The dopant PD has a photosensitive property. In the exemplary embodiment, the dopant PD may be doped into the whole of the body 5 at substantially the same concentration.

In the exemplary embodiment, the dopant PD may induce a reaction with light having a wavelength band. More specifically, a molecule coupled to the dopant PD absorbs the light so that a structure of the molecule may be changed and the molecule with the changed structure may have an increased refractive index.

In the exemplary embodiment, the dopant PD may include germanium. In another exemplary embodiment, the dopant PD may be one among other photosensitive dopants and may include, e.g., boron.

A first region A1 is defined in plural within the body 5. In the exemplary embodiment, the first regions A1 may be defined at an opposing surface S3 of the body 5 opposite to the emitting surface S2 thereof. In another exemplary embodiment, the first regions A1 may be defined at the emitting surface S2.

The first regions A1 may be spaced apart from each other. In an exemplary embodiment, for example, as illustrated in FIG. 1A, the first regions A1 may be defined in discrete shapes spaced apart from each other at the opposing surface S3. Where the light guide plate 50 defines a length and a width thereof, the first regions A1 may be spaced apart from each other in the lengthwise and/or the widthwise directions of the light guide plate 50.

The light guide pattern LP is defined by a first pattern layer portion P1 located inside the body 5 to correspond to each of the first regions A1. When the first pattern layer portion P1 has a first refractive index and intermediate portions of the body 5 between two first pattern layer portions P1 adjacent to each other has a second refractive index, the first refractive index is higher than the second refractive index. Accordingly, the first pattern layer portions P1 with the first refractive index and the intermediate portions with the second refractive index are defined to be alternately repeated inside the body 5 in a first direction D1, e.g., a longitudinal direction. In the exemplary embodiment, the first pattern layer portions P1 (or the first regions A1) and the intermediate portions of the body 5 may define a whole of the body 5 and/or a whole of the light guide plate 50. The first pattern layer portion P1 and the intermediate portion of the body 5 extends from the opposing surface S3 to the emitting surface S2. A cross-sectional thickness of the first pattern layer portion P1 and the intermediate portion may be the same as a total cross-sectional thickness of the body 5.

In a method of manufacturing the first pattern layer portion P1, when the body 5 is irradiated with light to expose an external surface portion thereof, a composition of a material at a portion of the body 5 is changed to form the first pattern layer portion P1. Therefore, the first pattern layer portion P1 of the light guide pattern LP and the body 5 are integrated. That is, the body 5 as including various structures of the dopant PD within portions of the body material defines the first pattern layer portion P1 of the light guide pattern LP. In more detail, in a cross-sectional view, the external surface portion irradiated with the light defines an exposed surface of the body, such as an exposed surface ES at the first pattern layer portion P1. The exposed surface ES is located on or defined in a plane of the opposing surface S3. That is, an external surface of the first pattern layer portion P1 is coplanar with an external surface of the body 5.

In an exemplary embodiment of a method of manufacturing a light guide plate, the dopant PD including germanium may be doped into the whole of the body 5 at substantially the same concentration and the body 5 may consequently include SiO₂ and GeO₂. In addition, according to an amount of germanium doped into the body 5, the body 5 may include oxygen deficient germanium (GeO) and the GeO may absorb light of a wavelength of about 240 nanometers (nm), so that a molecular structure of the GeO may be broken by the light. When the molecular structure of the GeO is broken by the light, an initial structure of the dopant PD is change such that a refractive index is locally increased at a portion of the body 5 irradiated with light, so that the first pattern layer portion P1 may be formed. The above-mentioned principle in which the first pattern layer portion P1 is formed in the body 5 may refer to a known method of manufacturing a Fiber Bragg grating.

In the exemplary embodiment, since GeO reacts with ultraviolet rays to exist as a different type of molecular structure to form the first pattern layer portion P1, GeO in the first pattern layer portion P1 may have a relatively lower concentration than GeO in other portions of the body 5 such as the intermediate portions thereof between the two first pattern layer portions P1 adjacent to each other. The first pattern layer portions P1 may be defined by the different molecular structure (e.g., broken) GeO within the body material and the intermediate layer portion may be defined by an initial molecular structure (e.g., non-broken) GeO within the body material.

When the first pattern layer portions P1 are arranged inside the body 5 in the first direction D1 at an interval, a difference between the first and second refractive indexes is periodically generated inside the body 5. Accordingly, when light traveling inside of the body 5 in the form of total reflection reaches the first pattern layer portion P1, the condition of total reflection is not met, and as a result, the light may be emitted outside of the light guide plate 50 through the emitting surface S2 at the first pattern layer portion P1.

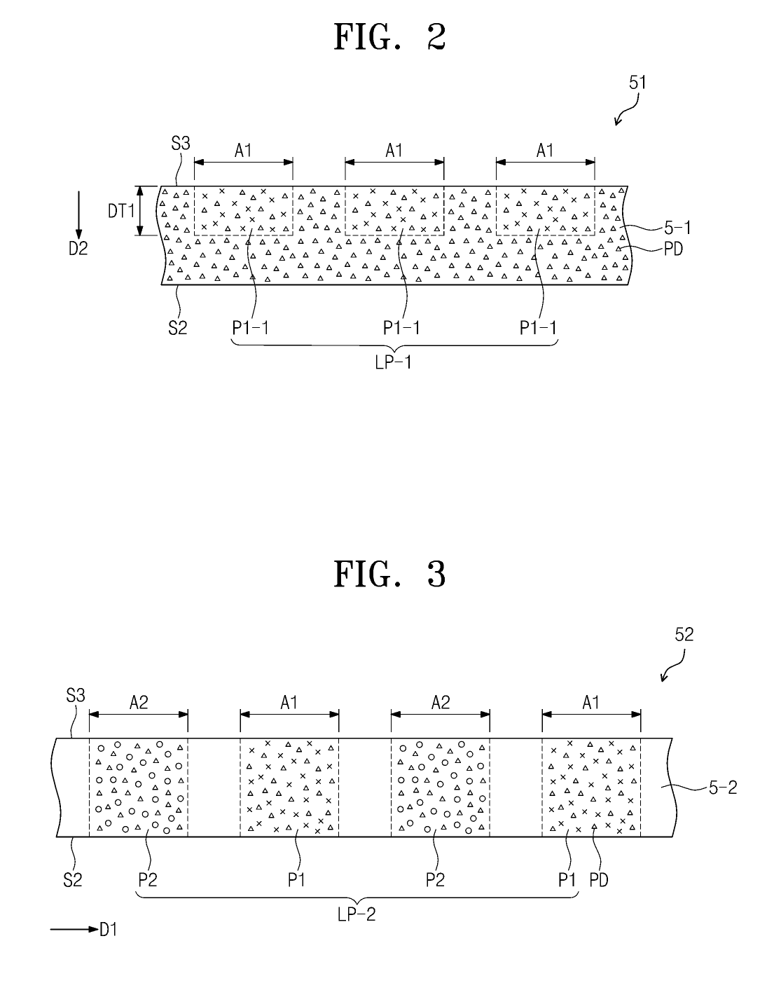

FIG. 2 illustrates a cross-sectional view of another exemplary embodiment of a light guide plate according to the invention, such as along line I-I′ in FIG. 1A. In the following description of FIG. 2, the same reference numerals will be given to the same components as those described above and duplicate description thereof will not be repeated.

Referring to FIG. 2, a light guide plate 51 includes a body 5-1 and a light guide pattern LP-1. The light guide pattern LP-1 includes a first pattern layer portion P1-1 at each of first regions A1.

As in the exemplary embodiment illustrated in FIG. 1B, the whole of the body 5-1 may be doped with a dopant PD and the first pattern layer portion P1-1 of the light guide pattern LP-1 may have a higher refractive index than the intermediate portion of the body 5-1 between two first pattern layer portions P1-1 adjacent to each other. In addition, the first pattern layer portion P1-1 and the body 5-1 may be integrated.

In the exemplary embodiment, the first pattern layer portion P1-1 may be defined extending from an opposing surface S3 of the body 5-1 to a depth DT1 in a second direction D2, e.g., a thickness direction of the body 5-1. Since the depth DT1 is less than a whole thickness of the body 5-1 in the second direction D, an overlapping portion of the body 5-1 is defined under the first pattern layer portion P1-1 and extending to an emitting surface S2. Accordingly, the overlapping portion of the body 5-1 under the first pattern layer portion P1-1 in the second direction D2 may have a lower refractive index than the first pattern layer portion P1-1. The refractive indices of the overlapping portion of the body 5-1 and the intermediate portion of the body 5-1 may be the same as each other, but the invention is not limited thereto.

The first pattern layer portions P1 may be defined by the different molecular structure (e.g., broken) dopant PD within the body material and the intermediate layer portion may be defined by an initial molecular structure (e.g., non-broken) dopant PD within the body material.

The reason the first pattern layer portion P1-1 is defined from the opposing surface S3 of the body 5-1 to the depth DT1 is detailed below. As in the exemplary embodiment described by referring to FIGS. 1A and 1B, a change in composition of a material in the body 5-1 is caused by irradiating the opposing surface S3 of the body 5-1 with light to form the first pattern layer portion P1-1. When the body 5-1 is irradiated with the light, the change in composition of a material of the body 5-1 sequentially proceeds from the opposing surface S3 in the second direction D2. Accordingly, by adjusting time during and/or intensity at which the body 5-1 is irradiated with the light, the first pattern layer portion P1-1 may be defined from the opposing surface S3 of the body 5-1 to the depth DT1, where the depth of the first pattern layer portion is less than a total thickness of the body 5-1.

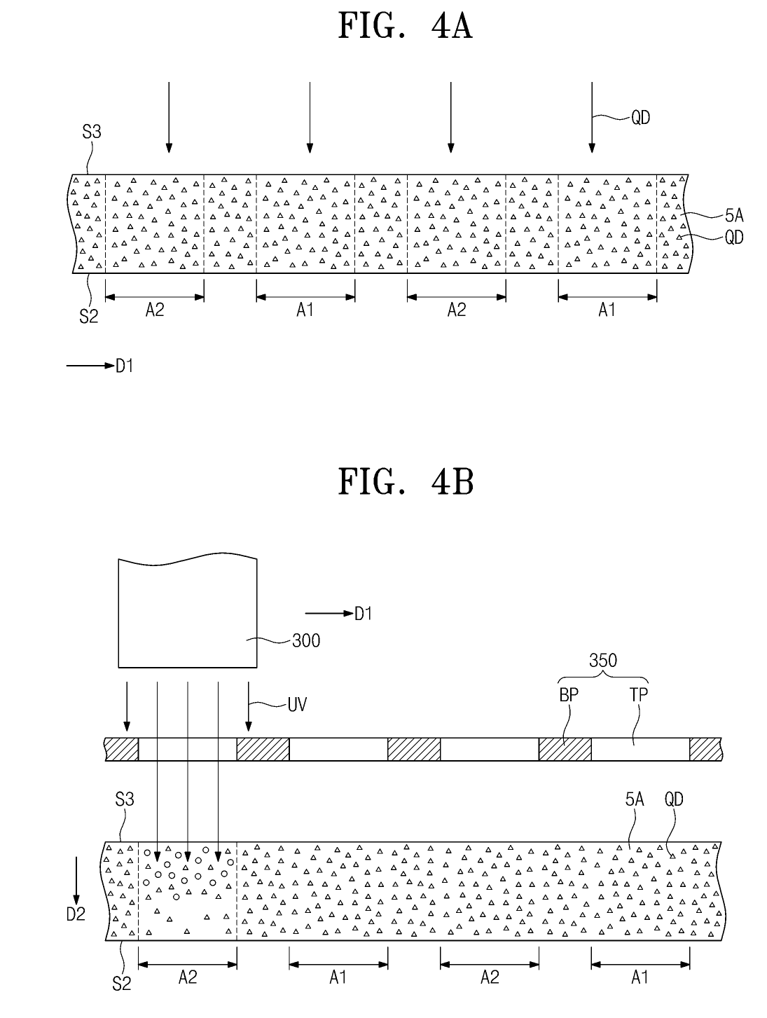

FIG. 3 illustrates a cross-sectional view of still another exemplary embodiment of a light guide plate according to the invention. In the following description of FIG. 3, the same reference numerals will be given to the same components as those described above and duplicate description thereof will not be repeated.

Referring to FIG. 3, a light guide plate 52 includes a body 5-2 and a light guide pattern LP-2. In the exemplary embodiment, the light guide pattern LP-2 includes first pattern layer portions P1 and second pattern layer portions P2 respectively disposed at first and second regions A1 and A2. The first regions A1 and the second regions A2 are respectively spaced apart from each other, and the first regions A1 and the second regions A2 are defined on the body 5-2 to be alternately repeated.

In the exemplary embodiment, the dopant PD is not doped into the whole of the body 5-2 but may be doped into the first and second regions A1 and A2 of the body 5-2. That is, the dopant PD may be doped into only the first and second regions A1 and A2 of the body 5-2 to define the first pattern layer portions P1 and second pattern layer portions P2, respectively. Therefore, the dopant PD of the first pattern layer portion P1 at the first region A1 of the body 5-2 or of the second pattern layer portion P2 at the second region A2 of the body 5-2 may have a higher concentration than the dopant doped into a remaining portion of the body 5-2 except for the first and second regions A1 and A2 of the body 5-2.

When the first and second pattern layers P1 and P2 of the light guide pattern LP-2 are arranged inside the body 5-2 in the first direction D1 at an interval and light traveling inside of the body 5-2 in the form of total reflection reaches the first and second pattern layer portions P1 and P2, the condition of total reflection is not met and thus the light may be emitted outside of the light guide plate 52 at the first and second pattern layer portions P1 and P2.

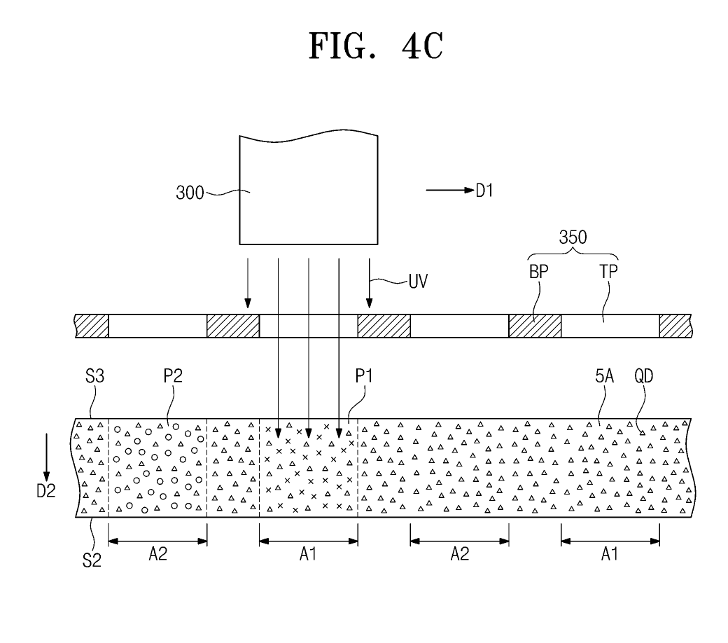

FIGS. 4A, 4B and 4C are drawings illustrating an exemplary embodiment of a method of manufacturing a light guide plate according to the invention. In the following description of FIGS. 4A to 4C, the same reference numerals will be given to the same components as those described above and duplicate description thereof will not be repeated.

Referring to FIG. 4A, a dopant QD having a photosensitive property is doped into a body 5A including a base or body material into which the dopant QD is disposed. In the exemplary embodiment, an ion implantation method may be used for doping the dopant QD into the body 5A, and the dopant QD may be doped into the whole of the body 5A at substantially the same concentration.

The first and second regions A1 and A2 may be defined in the body 5A and may be defined as regions of the body 5A to which light irradiated such as ultraviolet rays.

Referring to FIGS. 4B and 4C, a light irradiator 300 is disposed above the body 5A and a mask 350 is disposed between the light irradiator 300 and the body 5A. In the exemplary embodiment, the light irradiator 300 may irradiate ultraviolet rays UV.

The mask 350 may include a light shielding portion BP and a light transmitting portion TP. The light transmitting portion TP is a portion of the mask 350 through which the ultraviolet rays UV pass and may be aligned with the body 5A so as to overlap the first and second regions A1 and A2 at which light is to be irradiated.

The light shielding portion BP includes a light-blocking material such as metal to block the ultraviolet rays UV, and may overlap remaining regions of the body 5A to which light is not irradiated other than the first and second regions A1 and A2 of the body 5A.

With the mask 350 aligned over the body 5A, the light irradiator 300 irradiates the body 5A with the ultraviolet rays UV while moving in the first direction D1. By moving in the first direction D1 with the mask 350 aligned over the body 5A, the ultraviolet rays UV from the light irradiator 300 pass through the light transmitting portion TP of the mask 350 so that the first and second regions A1 and A1 of the body 5A are irradiated with the ultraviolet rays UV. Accordingly, since the composition of a material constituting the body 5A (e.g., the base material with the dopant QD disposed therein) is changed by the dopants QD doped into the body 5A being irradiated by the ultraviolet rays UV, a refractive index of the body 5A corresponding to the first and second regions A1 and A2 thereof is locally increased. In FIGS. 4B and 4C, for example, at the second region A2 to which the ultraviolet rays UV are irradiated, the composition of the body 5A is illustrated as having both triangles and circles, at the first region A1 to which the ultraviolet rays UV are irradiated, the composition of the body 5A is illustrated as having both triangles and crosses, whereas remaining portions of the body 5A still have only the triangles representing the initial dopant QD.

In the exemplary embodiment, each of the first regions A1 of the body 5A is irradiated with the ultraviolet rays UV for a first time, so that the first pattern layer portion P1 of a light guide pattern is formed at each of the first regions A1, and each of the second regions A2 of the body 5A is irradiated with the ultraviolet rays UV for a second time longer than the first time, so that the second pattern layer portion P2 of the light guide pattern is formed at each of the second regions A2 of the body 5A. Therefore, since an effect in which the refractive index of the body 5A is increased by the ultraviolet rays UV in the second regions A2 to be higher than that in the first regions A1, the refractive index at the second pattern layer portion P2 of the light guide pattern may be higher than that at the first pattern layer portion P1 of the light guide pattern.

In the exemplary embodiment, when the body 5A is irradiated with the ultraviolet rays UV, a change in composition of the material in the body 5A sequentially proceeds from the opposing surface S3 which is exposed outside the body 5A and in the second direction D2. Accordingly, by adjusting time during and/or intensity at which the body 5A is irradiated with the light, the depth of the body 5A into which each of the first and second pattern layer portions P1 and P2 is formed may be controlled.

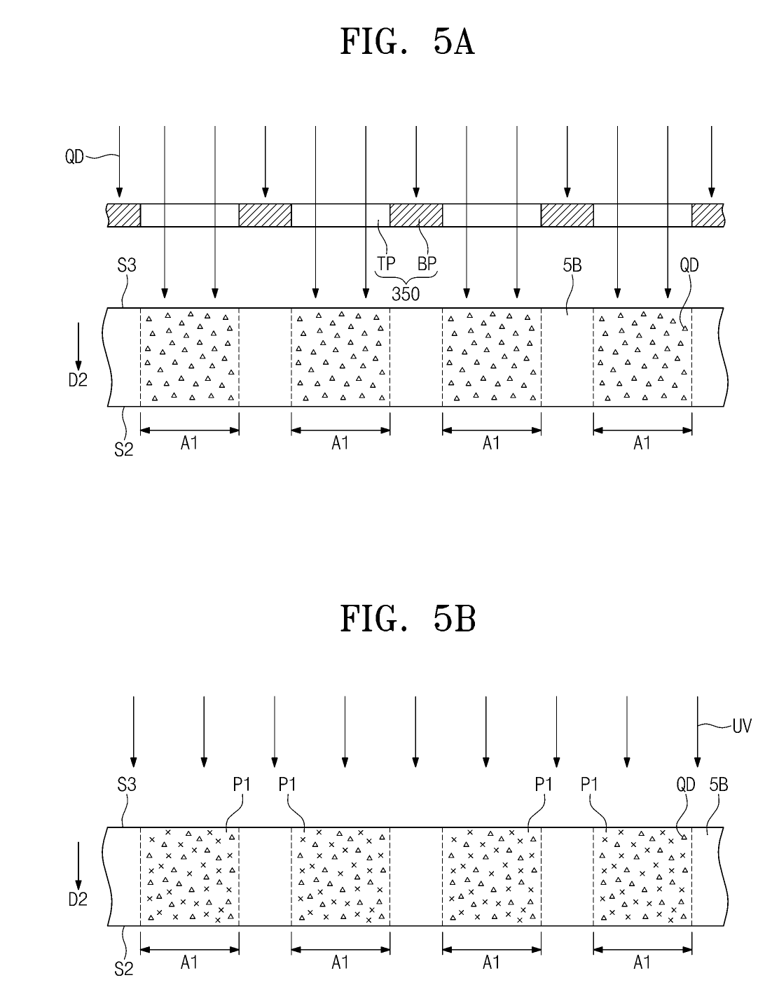

FIGS. 5A and 5B are drawings illustrating another exemplary embodiment of a method of manufacturing a light guide plate according to the invention. In the following description of FIGS. 5A to 5B, the same reference numerals will be given to the same components as those described above and duplicate description thereof will not be repeated.

Referring to FIG. 5A, a mask 350 with light transmitting portions TP and light shielding portions BP is disposed over a body 5B and then photosensitive dopants QD are provided from above the mask 350 towards the mask 350 and into the body 5B via the light transmitting portions TP of the mask 350.

The light transmitting portions TP is a portion of the mask 350 through which the dopants QD pass and may be aligned with the body 5B so as to be in one-to-one correspondence to the first regions A1 of the body 5B to overlap the first regions A1 thereof. As a result, the dopants QD are doped into the first regions A1 of the body 5B but are not doped into remaining portions of the body 5B other than the first regions A1 thereof.

Referring to FIG. 5B, the whole of the body 5B with the mask 350 disposed over the body 5B is irradiated with ultraviolet rays UV. As a result, molecules with the dopants QD doped into the first regions A1 react with the ultraviolet rays UV to form the first pattern layer portion P1 of a light guide pattern at each of the first regions A1 of the body.

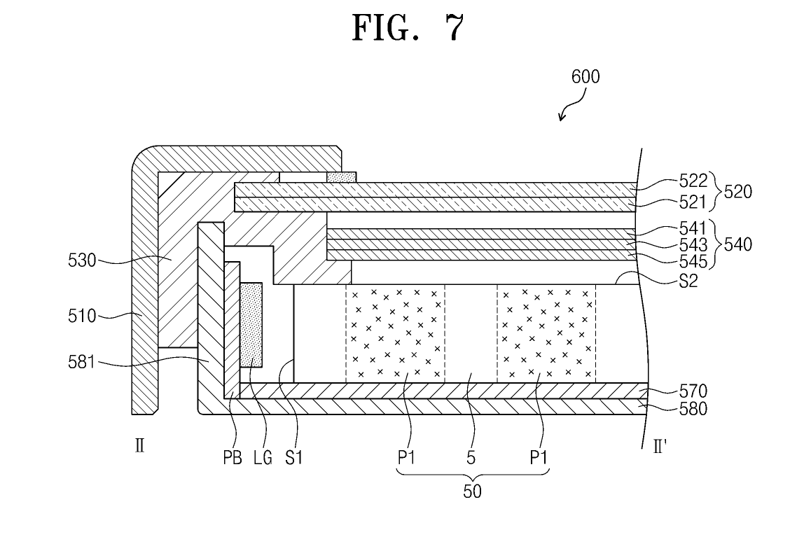

FIG. 6 illustrates an exploded perspective view of an exemplary embodiment of a display device to which the light guide plate illustrated in FIG. 1A is applied, and FIG. 7 illustrates a cross-sectional view illustrating the display device along line II-II′ in FIG. 6.

Referring to FIGS. 6 and 7, a display device 600 includes a backlight assembly 500 and a display panel 520. The backlight assembly 500 generates and emits light and the display panel 520 receives the light from the backlight assembly 500 to display an image.

In the exemplary embodiment, the display panel 520 may be a liquid crystal display panel and as such, the display panel 520 may include a first display substrate 521 in which a plurality of pixel electrodes is disposed, a second display substrate 522 in which a common electrode is disposed, and a liquid crystal layer (not shown) interposed between the first and second display substrates 521 and 522.

The backlight assembly 500 includes a receiving container 580, a reflection plate 570, a light guide plate 50, a mold frame 530, a plurality of sheets 540, a light emitting unit 100 and a cover member 510.

The receiving container 580 includes a bottom portion 585 and a side wall 581 provided in plural extending from the bottom portion 585 to receive components of the backlight assembly 500. In an exemplary embodiment of the invention, the light emitting unit 100 may be disposed on any one inner surface of the plurality of side walls 581. However, the invention is not limited thereto, and in another exemplary embodiment, the light emitting unit 100 is provided in plurality to be disposed on more than one inner surface of the plurality of side walls 581.

The light guide plate 50 is received in the receiving container 580, so that one side surface thereof faces the light emitting unit 100 to define an incident surface S1 thereof. The light guide plate 50 defines the incident surface S1, an opposing surface S3 and an emitting surface S2. Light generated from a light emitting diode package LG of the light emitting unit 100 is incident inside the light guide plate 50 through the incident surface S1, and the light incident inside the light guide plate 50 is provided toward the display panel 520 through the emitting surface S2.

The reflection plate 570 includes a material which reflects light, e.g., polyethylene terephthalate (“PET”) and aluminum, and is disposed between the bottom portion 585 of the receiving container 580 and the light guide plate 50. Accordingly, light which is generated from the light emitting unit 100 and is not incident toward the light guide plate 50 may be reflected by the reflection plate 570 and then incident again to the light guide plate 50.

The mold frame 530 is coupled to the receiving container 580 to support or fix edges of the light guide plate 50 with respect to the bottom portion 585 of the receiving container 580. Since a portion of the mold frame 530 extends in a direction parallel with the bottom portion 585, the plurality of sheets 540 and the display panel 520 may be mounted and supported on the portion of the mold frame 530.

The plurality of sheets 540 is disposed on the display panel 520. The plurality of sheets 540 may include optical sheets controlling a light path of light emitted from the light guide plate 50 and incident toward the display panel 520, and a protective sheet protecting a surface of the display panel 520. In the exemplary embodiment of the invention, the plurality of sheets 540 may include a protective sheet 541 protecting a rear surface of the display panel 520, a prism sheet 543 enhancing brightness of a front surface 543, and a diffusion sheet 545 diffusing light.

The light emitting unit 100 generates light used by the display panel 520 to display an image. The light emitting unit 100 includes a printed circuit board PB and the light emitting diode package LG provided in plural mounted on the printed circuit board PB. The plurality of light emitting diode packages LG uses power provided from the printed circuit board PB to emit light and may be arranged along the incident surface S1.

A portion of the cover member 510 is opened so as to expose a display region of the display panel 520 and the cover member 510 covers edges of the display panel 520 to be coupled to the receiving container 580. As the cover member 510 is coupled to the receiving container 580, the components of the backlight assembly 500 may be stably fixed inside the receiving container 580.

As previously described with reference to FIGS. 1A and 1B, the light guide plate 50 is defined by the body 5 including glass and the first pattern layer portions P1 defined inside the body 5 and spaced apart from each other. The first pattern layer portions P1 are arranged spaced apart from each other inside the light guide plate 50 in a direction moving away from the incident surface S1, and the first refractive index of the light guide plate 50 at the first pattern layer portions P1 is higher than the second refractive index of the light guide plate 50 at remaining portions of the light guide plate 50 other than the first pattern layer portions P1.

Accordingly, light generated from the light emitting diode packages LG is incident inside the light guide plate 50 through the incident surface S1 and then the light may be totally reflected inside of the body 5. In addition, when light totally reflected inside of the body 5 reaches the first pattern layer portions P1, the condition of total reflection is not met, so that the light may be emitted outside of the light guide plate 50 through the emitting surface S2 and thus be guided toward the display panel 520.

According to one or more exemplary embodiment of the invention, since a light guide pattern is formed within a light guide plate body by irradiating a glass body doped with a photosensitive dopant with light, etching the glass body or forming an additional pattern on and separate from the glass body so as to form a light guide pattern of a conventional light guide plate is omitted. Therefore, in one or more exemplary embodiment of the invention, processes applied to a glass body for manufacturing a light guide plate may be easily performed as compared to the conventional light guide plate.

While the invention has been particularly shown and described with reference to exemplary embodiments thereof, it will be understood by those of ordinary skill in the art that various changes in form and details may be made therein without departing from the substantial features of the exemplary embodiments. Hence, the technical scope of the invention shall be determined not by detailed description but by the technical scope of the accompanying claims.

What is claimed is:

1. A light guide plate comprising:
a body including glass doped with a dopant having photosensitivity and in which first regions spaced apart from each other are defined,
the body defining a light guide pattern of the light guide plate,
the light guide pattern comprising a first pattern layer portion provided in plural inside the body to correspond to each of the first regions,
wherein a refractive index of the first pattern layer portion is higher than a refractive index of an intermediate portion of the body between two first pattern layer portions adjacent to each other.

2. The light guide plate of claim 1, wherein
the body further defines an external surface thereof,
the first pattern layer portion defines an external surface thereof coplanar with the external surface of the body, and
the first pattern layer portion extends from the external surface of the body in a thickness direction of the body.

3. The light guide plate of claim 1, wherein the dopant comprises at least one of germanium and boron.

4. The light guide plate of claim 3, wherein
the dopant comprises germanium (Ge), and
a concentration of oxygen deficient germanium (GeO) in the first pattern layer portion is lower than a concentration of oxygen deficient germanium (GeO) in the intermediate portion of the body between the two first pattern layer portions adjacent to each other.

5. The light guide plate of claim 2, wherein
the body further includes second regions defined therein, the second regions spaced apart from the first regions,
the light guide pattern further comprises a second pattern layer portion provided in plural inside the body to correspond to each of the second regions,
wherein
the first and second pattern layer portions are alternately arranged in a lengthwise direction of the body, and
a refractive index of the second pattern layer portion is higher than that of the first pattern layer portion.

6. The light guide plate of claim 1, wherein the dopant is doped into a whole of the body.

7. The light guide plate of claim 1, wherein a concentration of the dopant doped at the first pattern layer portion is higher than a concentration of the dopant at the intermediate portion of the body between the two first pattern layer portions adjacent to each other.

8. A method of manufacturing a light guide plate, comprising:
doping a dopant having photosensitivity into glass to define a body of the light guide plate; and
irradiating first regions of the body with light to form a first pattern layer portion of a light guide pattern of the light guide plate, the first pattern layer portion provided in plural inside the body to correspond to each of the first regions,
wherein a refractive index of the first pattern layer portion is higher than a refractive index of an intermediate portion of the body between two first pattern layer portions adjacent to each other.

9. The method of claim 8, wherein
the body defines an external surface thereof,
the first pattern layer portion defines an external surface thereof coplanar with the external surface of the body, and
the first pattern layer portion extends from the external surface of the body in a thickness direction of the body.

10. The method of claim 9, further comprising irradiating second regions of the body spaced apart from the first regions of the body, with the light to form a second pattern layer portion of the light guide pattern of the light guide plate, the second pattern layer portion provided in plural inside the body to correspond to each of the second regions,
wherein
the first and second pattern layer portions are alternately arranged in a lengthwise direction of the body,
the first regions of the body are irradiated with the light for a first time to form the first pattern layer portions,
the second regions of the body are irradiated with the light for a second time longer than the first time to form the second pattern layer portions, and
a refractive index of the second pattern layer portion is higher than that of the first pattern layer portion.

11. The method of claim 9, wherein the dopant comprises at least one of germanium (Ge) and boron (B).

12. The method of claim 11, wherein
the dopant comprises germanium (Ge), and
a concentration of oxygen deficient germanium (GeO) in the first pattern layer portion is lower than a concentration of oxygen deficient germanium (GeO) in the intermediate portion of the body between the two first pattern layer portions adjacent to each other.

13. The method of claim 8, wherein
the dopant is doped into a whole region of the body, and
for the body in which the whole region thereof is doped with the dopant, the irradiating the first regions of the body includes irradiating the body with the light by using a mask.

14. The method of claim 8, wherein
the dopant is doped into only the first regions of the body by using a mask, and
for the body in which only the first regions thereof are doped with the dopant, the irradiating the first regions of the body includes irradiating a whole region of the body with the light.

15. A display device comprising:
a backlight assembly which generates and emits; and
a display panel which receives the light to display an image, wherein the backlight assembly comprises:
a light source which generates the light; and
a light guide plate which guides the light from the light source toward the display panel, wherein the light guide plate comprises:
a body including glass doped with a dopant having photosensitivity and in which first regions spaced apart from each other are defined,
the body defining a light guide pattern of the light guide plate,
the light guide pattern comprising a first pattern layer portion provided in plural inside the body to correspond to each of the first regions,
wherein a refractive index of the first pattern layer portion is higher than a refractive index of an intermediate portion of the body between two first pattern layer portions adjacent to each other.

16. The display device of claim 15, wherein
the body further defines an external surface thereof,
the first pattern layer portion defines an external surface thereof coplanar with the external surface of the body, and
the first pattern layer portion extends from the external surface of the body in a thickness direction of the body.

17. The display device of claim 15, wherein the dopant comprises at least one of germanium and boron.

18. The light guide plate of claim 17, wherein
the dopant comprises germanium (Ge), and
a concentration of oxygen deficient germanium (GeO) in the first pattern layer portion is lower than a concentration of oxygen deficient germanium in the intermediate portion of the body between the two first pattern layer portions adjacent to each other.

19. The display device of claim 15, wherein the dopant is doped into a whole of the body.

20. The display device of claim 15, wherein a concentration of the dopant doped at the first pattern layer portion is higher than a concentration of the dopant at the intermediate portion of the body between the two first pattern layer portions adjacent to each other.
